(19) United States
(12) Patent Application Publication
(10) Pub. No.: US 2020/0039051 A1
(43) Pub. Date: Feb. 6, 2020

(54) HAND TOOL FOR IMPROVING TORQUE

(71) Applicant: YIH CHENG FACTORY CO., LTD., Nantuo (TW)

(72) Inventor: Jack LIN, Nantuo (TW)

(21) Appl. No.: 16/052,602

(22) Filed: Aug. 1, 2018

(51) Int. Cl. B25G 1/00; B25G 1/10

(52) U.S. Cl. CPC B25G 1/005; B25G 1/102

(57) ABSTRACT

A hand tool for improving torque is provided. The handle tool includes a metal rod, a handle and a polygonal portion. The metal rod includes a first head, a first end and an operation section between the first head and the first end. The operation section includes a uniform outside diameter. The handle partially receives the metal rod and has a second head and a second end. The polygonal portion is formed on the operation section and exposed from the second head. The polygonal portion has a largest outside diameter. The largest outside diameter is equal to the uniform outside diameter. Accordingly, the metal rod has improved structural strength, does not break easily and facilitates ergonomic operations.

### TECHNICAL FIELD

The present invention relates to a hand tool and, in particular, to a hand tool for improving torque, wherein the hand tool has good structural strength to resist breaking and conforms to ergonomics.

### BACKGROUND

In hand tools such as screwdrivers, there are some drawbacks with their conventional products. Major drawbacks are detailed as follows.

A rotating part for rotating the hand tool is assembled to a metal rod. The rotating part protrudes from the metal rod, which means that the largest outside diameter of the rotating part is larger than that of the metal rod. Although such design can increase torque, it also generates a shear force between the rotating part and the metal rod, so breakage tends to occur between the rotating part and the metal rod.

The rotating part is disposed at an end of the metal rod. A distance between a force-applying end (the end of the metal rod) and a force-bearing end (i.e. a head of the metal rod) is too long, so the metal rod needs to be strong enough to resist bending or other structural damage, leading to high production costs. In addition to that, this configuration does not conform to ergonomics. The rotating part disposed at the end of the metal rod hinders users' operations since most users get used to place their palms on a handle and at the end of the metal rod.

In view of this, the inventor studied various technologies and created an effective solution in the present disclosure.

### SUMMARY

It is an objective of the present invention to provide a hand tool for improving torque, wherein the hand tool has good structural strength to prevent it from being broken and conforms to ergonomics.

Accordingly, the present invention provides a hand tool for improving torque. The hand tool includes a metal rod, a handle and a polygonal portion. The metal rod includes a first head, a first end and an operation section between the first head and the first end. The operation section includes a uniform outside diameter. The handle partially encloses the metal rod and has a second head and a second end. The polygonal portion is formed on the operation section and exposed from the second head of the handle. The polygonal portion has a largest outside diameter, and the largest outside diameter is equal to the uniform outside diameter.

Compared with conventional techniques, the present invention has the following effects. The largest diameter is equal to the uniform diameter, so that the metal rod has superior structural strength and does not break easily. The polygonal portion is exposed from the second head of the handle to allow for ergonomic operations.

### BRIEF DESCRIPTION OF THE DRAWINGS

The disclosure will become more fully understood from the detailed description and the drawings given herein below for illustration only, and thus does not limit the disclosure, wherein:

FIG. 1 is a perspective exploded view illustrating a hand tool and a rod member;

FIG. 2 is a perspective assembled view based on FIG. 1;

FIG. 3 is a partial cross-sectional view based on FIG. 2; and

FIG. 4 is a cross-sectional view illustrating that the hand tool has improved torque by means of a wrench.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

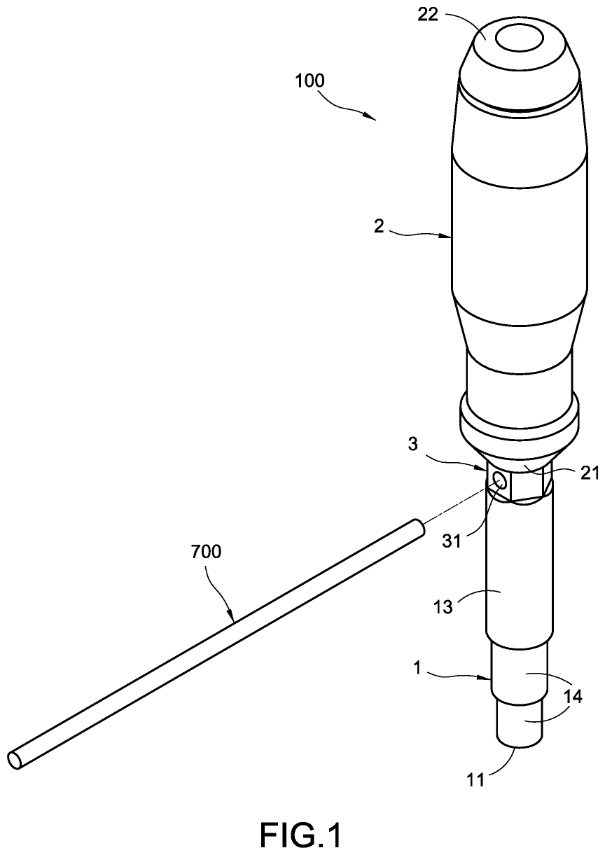

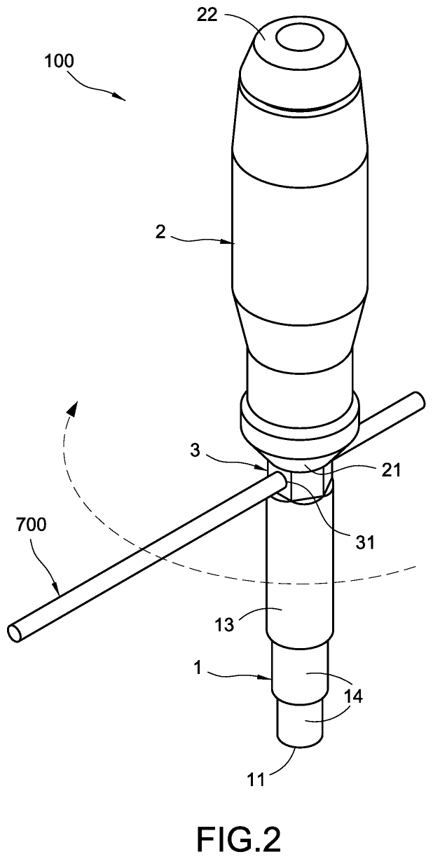

Referring to FIGS. 1 to 3, the present invention provides a hand tool for improving torque. With an assistance tool, torque of the hand tool 100 can increase. The hand tool 100 can be a simple screwdriver (not illustrated) and can be a screwdriver with interchangeable tool heads as shown in the drawings; the present invention is not limited in this regard. The tool hand 100 includes a metal rod, a handle 2 and a polygonal portion 3.

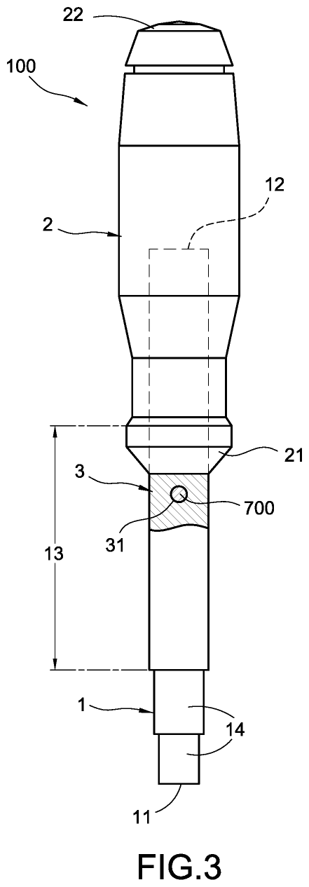

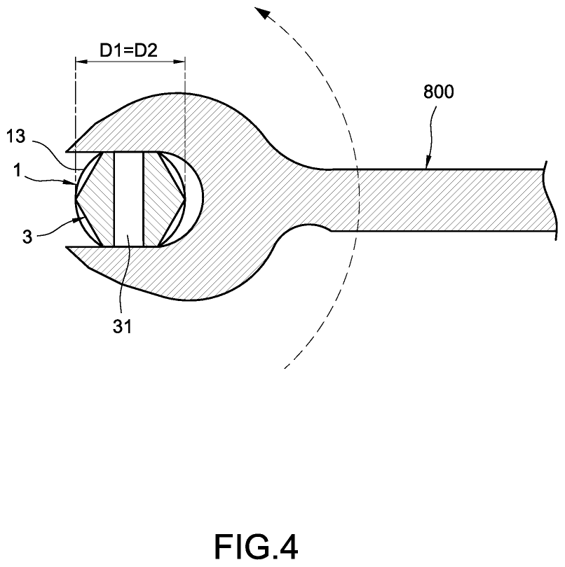

The metal rod 1 is a rod consisting of metal. The metal rod 1 has a first head 11, a first end 12 (see FIG. 3) and an operation section 13, and preferably further includes an extending section 14. The metal rod 1 has an axial direction parallel to a length direction of the metal rod 1. In other words, the axial direction is a direction from the first head 11 to the first end 12 or a direction from the first end 12 to the first head 11. The extending section 14 is extended along the axial direction from one end of the operation section 13 and is integrally formed (in a one-piece form) with the operation section 13. The operation section 13 is disposed between the first head 11 and the first end 12, and the operation section 13 has a uniform outside diameter D1 (see FIG. 4). In other words, the operation section 13 has only one outside diameter before the polygonal portion 3 is formed/manufactured. The operation section 13 can be of round cross section for example.

The handle 2 partially encloses the metal rod 1 and exposes another portion of the metal rod 1. The handle 2 has a second head 21 and a second end 22. By this way, the first end 12 of the metal rod 1 can be disposed inside the handle 2 (see FIG. 3). Alternatively, the first end 12 of the metal rod 1 can be lengthened (not illustrated) to be flush with or protrudes from the second end 22 of the handle 2. The present invention is not limited in this regard. In the present embodiment, the first end 12 is disposed inside the handle 2 as an example.

The polygonal portion 3 is formed on the operation section 13 of the metal rod 1 and is integrally formed (in one-piece form) with the operation section 13 of the metal rod 1. The polygonal portion 3 is partially exposed (see FIG. 3) or entirely exposed (not illustrated) from the second head 21 of the handle 2. For partial exposure, the polygonal portion 3 is partially enclosed by the handle 2.

In detail, the metal rod 1 is divided into two segments, one of the two segments of the metal rod 1 is an internal section enclosed inside the handle 2, the other one of the two segments includes the operation section 13 and the extending section 14 extended from the operation section 13. The operation section 13 is partially enclosed inside the handle 2 with a portion of the polygonal portion 3 (i.e. the operation section 13 is extended into the handle 2 with a portion of the polygonal portion 3), and another portion of the polygonal portion 3 is exposed from the second head 21 of the handle 2.

Since the another portion of the polygonal portion 3 is exposed from the second head 21 of the handle 2, the polygonal portion 3 is at a junction where the second head 21 of the handle 2 joins the metal rod 1. The junction is adjacent to the second head 21 of the handle 2, so it is convenient for a user to operate by his/her both hands. That is to say, the user grips the handle 2 by one hand, and his/her the other hand rotates the polygonal portion 3 with the assistance tool. The metal rod 1 is rotated by rotation of the polygonal portion 3. This ergonomic configuration facilitates rotating the hand tool 100 by hands.

Referring to FIGS. 3 and 4, the polygonal portion 3 has a largest outside diameter D2, the largest outside diameter D2 is equal to the uniform outside diameter D1. In other words, the largest diameter D2 of the polygonal portion 3 is equal to the uniform outside diameter D1 (see FIG. 3) of the operation section 13 of the metal rod 1. This configuration eliminates (or reduces) shear forces between the polygonal portion 3 and the metal rod 1 or between the polygonal portion 3 and the operation section 13. This means that the structural strength between the polygonal portion 3 and the operation section 13 is improved to resist breaking. There are various ways to form the polygonal portion 3 on the operation section 13—including, for example, cutting the periphery of the operation section 13 to form thereon multiple cutting sides.

In short, in the hand tool 100, the largest outside diameter D2 of the polygonal portion 3 is equal to the uniform outside diameter D1 of the operation section 13, so that no shear force (or less shear force) occurs during rotation of the metal rod 1. Thus, the structural strength is improved to resist breaking. Besides, the polygonal portion 3 is exposed from the second head 21 of the handle, thereby facilitating ergonomic operations.

The polygonal portion 3 preferably includes an insertion hole 31. The insertion hole 31 is formed on the portion of the polygonal portion exposed from the second head 21. The insertion hole 31 can be a through hole shown in the drawing or a blind hole (not illustrated); the present invention is not limited in this regard. The insertion hole 31 is formed along a radial direction, and the radial direction is perpendicular to the axial direction mentioned above; however, the present invention is not limited to the radially formed insertion hole 31, and the insertion hole 31 can be formed along any direction which intersects the axial direction.

Referring to FIGS. 1 to 3, to increase torque, the user grips the assistance tool by the other hand. The assistance tool can be a rod member 700 (e.g. a simple rod element or another screwdriver). Then, by inserting one end of the rod member 700 into the insertion hole 31, greater leverage (resulting from a long lever arm from the other end of the rod member 700 to the polygonal portion 3) can be obtained to rotate the polygonal portion 3, so the torque increases to drive rotation of the handle tool 100.

Referring to FIG. 4, if the rod member 400 or the like is not available, and only a wrench 800 or other similar tools are available, then the user can use the wrench 800 to clamp the polygonal portion 3. This way still generates a greater leverage to rotate the polygonal portion 3. In other words, the hand tool 100 is rotated by the improved torque.

When the hand tool 100 is a screwdriver with interchangeable tool heads, the first head 11 of the metal rod 1 is a driving sleeve (not labelled). A tool head (an I-shaped or cross-shaped screwdriver tip) can be selectively coupled into the driving sleeve.

In summary, the hand tool for improving torque can achieve anticipated objectives and solve the conventional defects. The present invention also has novelty and non-obviousness, so the present invention completely complies with the requirements of patentability. Therefore, a request to patent the present invention is filed pursuant to patent law. Examination is kindly requested, and allowance of the present application is solicited to protect the rights of the inventor.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A hand tool for improving torque, comprising:
a metal rod, the metal rod including a first head, a first end and an operation section between the first head and the first end, the operation section including a uniform outside diameter;
a handle, the handle partially enclosing the metal rod and having a second head and a second end; and
a polygonal portion, the polygonal portion being formed on the operation section and exposed from the second head of the handle, the polygonal portion having a largest outside diameter, the largest outside diameter being equal to the uniform outside diameter.

2. The hand tool for improving torque according to claim 1, wherein the operation section is extended into the handle with a portion of the polygonal portion, and another portion of the polygonal portion is exposed from the second head of the handle.

3. The hand tool for improving torque according to claim 1, wherein the metal rod is divided into two segments, one of the two segments of the metal rod is an internal section, the other one of the two segments includes the operation section, the internal section is enclosed inside the handle, the operation section is enclosed inside the handle within a portion of the polygonal portion, and another portion of the polygonal portion is exposed from the second head of the handle.

4. The hand tool for improving torque according to claim 3, wherein the other one of the two segments includes an extending section extended from the operation section.

5. The hand tool for improving torque according to claim 1, wherein the first end of the metal rod is flush with or protrudes from the second end of the handle.

6. The hand tool for improving torque according to claim 1, wherein the first end of the metal rod is disposed inside the handle.

7. The hand tool for improving torque according to claim 1, wherein the first head of the metal rod is a driving sleeve, and a tool head is selectively coupled into the driving sleeve.

8. The hand tool for improving torque according to claim 1, wherein an insertion hole is formed on a portion of the polygonal portion exposed from the second head.

9. The hand tool for improving torque according to claim 8, wherein the insertion hole is a through hole.

10. The hand tool for improving torque according to claim 8, wherein the insertion hole is a blind hole.
